(19) United States
(12) Patent Application Publication
(10) Pub. No.: US 2015/0227931 A1
(43) Pub. Date: Aug. 13, 2015

(54) SYSTEM AND METHOD FOR AUTHORIZING A TRANSACTION

(71) Applicant: MASTERCARD ASIA PACIFIC PTE. LTD., Singapore (SG)

(72) Inventor: Ruben Salazar GENOVEZ, Singapore (SG)

(73) Assignee: MASTERCARD ASIA PACIFIC PTE. LTD., Singapore (SG)

(21) Appl. No.: 14/617,233

(22) Filed: Feb. 9, 2015

(30) Foreign Application Priority Data
Feb. 12, 2014 (SG) 2014012033

(51) Int. Cl. G06Q 20/40; G06F 21/32

(52) U.S. Cl. CPC G06Q 20/4012; G06F 21/32; G06Q 20/40145; G06Q 2220/00

(57) ABSTRACT

The system comprises: a biometric scanner configured to obtain biometric information from a user; a controller configured to receive the obtained biometric information from the biometric scanner and to generate a transaction code based on the obtained biometric information, the controller being further configured to receive account data relating to an account of the user; a server configured to receive the account data and the transaction code from the controller; a database in communication with the server and having stored thereon the account data in association with a registered code, the registered code having been generated based on pre-obtained biometric information of the user; and wherein the server is operable to use the account data to identify the registered code and to authorize the transaction based on a comparison of the registered code with the transaction code.

### FIELD OF INVENTION

The invention relates to a system and a method for authorizing a transaction.

### BACKGROUND

Currently, users typically provide a non-confidential user identifier (e.g., a user ID) and a confidential personal identification number (PIN) to gain access to a system. In this way, the PIN is used to authenticate the user to the system. Upon receiving the user ID and PIN, the system retrieves a registered PIN (that is stored in the system) based on the user ID and compares the registered PIN with the received PIN. The user is granted access only if the received PIN matches the registered PIN number. PINs are commonly used for automated teller machines (ATMs) and at points of sale (POS) for debit cards and credit cards. However, this method of authentication requires that the user remembers his PIN. If the user forgets his PIN, he would not be able to complete the transaction. He would need to seek the system administrator's assistance to retrieve his PIN or reset his PIN.

A need therefore exists to provide a system and a method for authorizing a transaction that seeks to address at least the above-mentioned problems.

### SUMMARY

According to the first aspect of the invention, there is provided a system for authorizing a transaction, comprising: a biometric scanner configured to obtain biometric information from a user; a controller configured to receive the obtained biometric information from the biometric scanner and to generate a transaction code based on the obtained biometric information, the controller being further configured to receive account data relating to an account of the user; a server configured to receive the account data and the transaction code from the controller; a database in communication with the server and having stored thereon the account data in association with a registered code, the registered code having been generated based on pre-obtained biometric information of the user; and wherein the server is operable to use the account data to identify the registered code and to authorize the transaction based on a comparison of the registered code with the transaction code.

In an exemplary embodiment, the server may be operable to authorize the transaction if the transaction code corresponds with or matches the registered code; and the server may be operable to decline the transaction if the transaction code does not correspond with or match the registered code.

In an embodiment, the system may further comprise a first encryptor in communication with the controller, the first encryptor configured to encrypt the obtained biometric information such that the controller generates the transaction code based on the encrypted biometric information. The system may further comprise a second encryptor in communication with the controller, the second encryptor configured to encrypt the generated transaction code such that the controller sends the encrypted transaction code to the server.

In an embodiment, the biometric scanner may comprise a fingerprint scanner configured to generate a digital representation based on a fingerprint of the user, and the biometric information may comprise the digital representation.

In an embodiment, the biometric scanner may comprise an image capturing device configured to generate a digital representation based on an iris or retina of the user, and the biometric information may comprise the digital representation.

In an embodiment, the account data may comprise one or more of: an account number, a credit card number, a user's name.

In an embodiment, the database may store the account data in association with user information and the server may be further operable to provide the user information to the controller if the transaction is authorized.

In an embodiment, the server may be further operable to permit funds to be taken from the account if the transaction is authorized.

In an embodiment, the controller may be further configured to receive transaction data; and the server may be further configured to receive the transaction data from the controller; and wherein the server may be operable to authorize the transaction based on the transaction data.

In an embodiment, the transaction data may comprise a transaction amount and the database may store the account data in association with an amount of available funds in the account, wherein the server may be operable to use the account data to identify the amount of available funds in the account and to authorize the transaction only if the amount of available funds in the account is equal to or greater than the transaction amount.

In an embodiment, the controller may be configured to generate the transaction code and registered code by converting the biometric information of the user into alphanumeric, numeric or binary codes.

According to the second aspect of the invention, there is provided a method of authorizing a transaction, the method comprising: obtaining biometric information from a user; receiving account data relating to an account of the user; generating a transaction code based on the obtained biometric information; storing the account data in association with a registered code, the registered code having been generated based on pre-obtained biometric information of the user; using the account data to identify the registered code; and authorizing the transaction based on a comparison of the registered code with the transaction code.

In an embodiment, authorizing may comprise authorizing the transaction if the transaction code corresponds with or matches the registered code. In an embodiment, authorizing may also comprise declining the transaction if the transaction code does not correspond with or match the registered code.

In an embodiment generating may comprise: encrypting the obtained biometric information; and generating the transaction code based on the encrypted biometric information.

In an embodiment, the method may further comprise encrypting the generated transaction code.

In an embodiment, the method may further comprise the step of permitting funds to be taken from the account if the transaction is authorized.

In an embodiment, the method may further comprise receiving transaction data; and wherein authorizing the transaction is based on the transaction data.

In an embodiment, storing may comprise storing the account data in association with an amount of available funds in the account, wherein using may comprise using the account data to identify the amount of available funds in the account, wherein the transaction data may comprise a transaction amount, and wherein authorizing may comprise authorizing the transaction only if the amount of available funds in the account is equal to or greater than the transaction amount.

In an embodiment, the method may further comprise the step of generating the transaction code and registered code by converting the biometric information of the user into alphanumeric, numeric or binary codes.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1 is a schematic diagram of a system for authorizing a transaction, according to an embodiment of the invention;

FIG. 2 is a flow chart illustrating a method of authorizing a transaction, according to an embodiment of the invention;

FIG. 3 is a sequence diagram of a method of authorizing a transaction, according to an embodiment of the invention; and

FIG. 4 is a schematic of a computer system for implementing the system and method for authorizing a transaction in example embodiments of the invention.

### DETAILED DESCRIPTION

Embodiments of the present invention will be described, by way of example only, with reference to the drawings. Like reference numerals and characters in the drawings refer to like elements or equivalents.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “obtaining”, “receiving”, “storing”, “using”, “authorizing” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

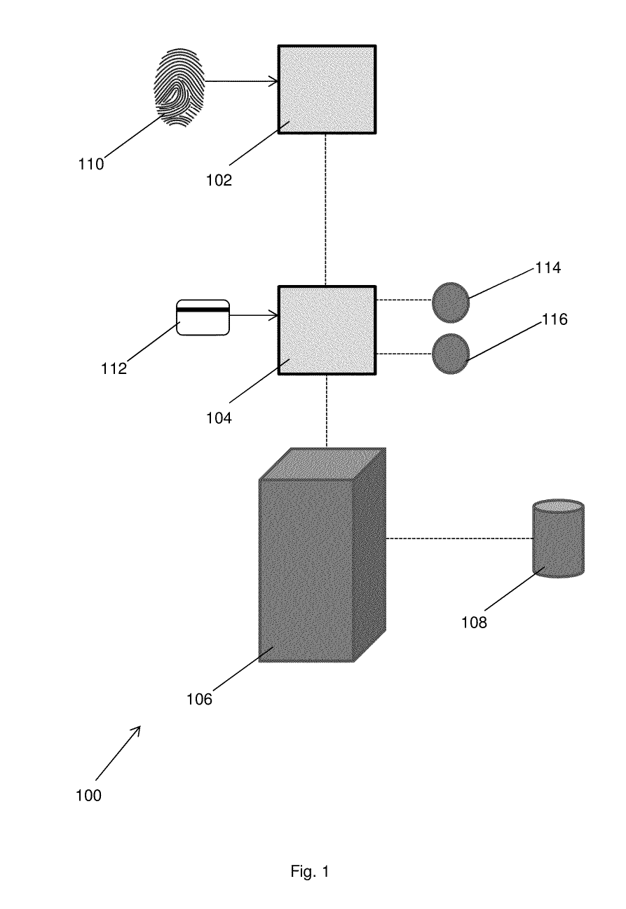

Embodiments of the present invention relate to a system and a method for authorizing a transaction. With reference to FIG. 1, according to an embodiment of the present invention, there is provided a system 100 for authorizing a transaction, comprising the following components:
1. A biometric scanner 102 configured to obtain biometric information 110 from a user. The type of biometric scanner 102 used depends on the biometric identifier (e.g., fingerprint, DNA, face, iris, retina, etc.) that the user is requested to provide for authentication.
   For example, the biometric scanner 102 may be a fingerprint scanner configured to generate a digital representation based on a fingerprint of the user, and the biometric information 110 comprises the digital representation. In this example, the digital representation may be a digital image of the fingerprint or a digital code which corresponds to physical features of the fingerprint. The fingerprint scanner may be built into a mobile electronic device such as a mobile phone or tablet computer. For example, the fingerprint scanner may be built into the touch-screen of the mobile electronic device so that a user's fingerprint can be scanned when the user swipes his finger across the touch-screen.
   The biometric scanner 102 may also be an image capturing device configured to generate a digital representation based on an iris or retina of the user, and the biometric information comprises the digital representation. In this example, the digital representation may be a digital image of the iris or retina of the user or a digital code which corresponds to physical features of the iris or retina. The image capturing device may be a camera of a mobile electronic device such as a mobile phone or tablet computer.
   It will be understood by a person skilled in the art that the generation of a digital representation based on a biometric identifier of the user may involve a pre-processing step (e.g., removal of background noise) and a feature extraction step. Such steps are known in the art, are not the focus of the invention, and therefore will not be elaborated further.
   Additionally, it is to be understood that the biometric scanner 102 may be configured to obtain biometric information based on a variety of different biometric identifiers. Further non-limiting examples of suitable biometric identifiers include: a face, DNA, a palm, a hand, an odor/scent, voice and gait. Also the biometric scanner 102 may be configured to obtain biometric information based on one or more different types of biometric identifiers.
2. A controller 104 configured to receive the obtained biometric information from the biometric scanner 102 and to generate a transaction code based on the obtained biometric information.
   In an example embodiment, the controller 104 is also configured to receive pre-obtained biometric information from the biometric scanner 102 and to generate a registered code based on the pre-obtained biometric information.
   The transaction and registered codes may be generated by extracting the features of the biometric identifier and using an algorithm to convert the features into the transaction and registered codes, as would be known to a person skilled in the art. The precise process used is beyond the scope of the present invention.
   Alternatively, a separate controller (that is functionally similar to controller 104) can be configured to receive pre-obtained biometric information from a separate biometric scanner (that is functionally similar to biometric scanner 102) and to generate the registered code based on the pre-obtained biometric information. For example, the separate biometric scanner may be located at a bank. More details on the registered code will be provided below.
   Both the transaction and registered code may comprise symbols, characters (e.g., letters and/or numbers) or any other representations. In an example embodiment, the controller is configured to generate the transaction code and registered code by converting the biometric information of the user into alphanumeric, numeric or binary codes. In other words, the transaction and registered codes may be alphanumeric, numeric, or binary codes. Preferably, both the transaction and registered codes are of the same type (e.g., alphanumeric, numeric, or binary) so that the transaction code obtained from a user during the transaction can be easily compared to the registered code that was pre-obtained from the same user.
   In an example embodiment, the registered code is generated only once by obtaining the biometric data beforehand (i.e., pre-obtained) during an enrollment phase while the transaction code is obtained during the transaction process and is utilized to compare, verify, validate, and/or match the registered code with the purpose of approving or declining a payment transaction. Further details will be provided below.
   The controller 104 can be further configured to receive account data 112 relating to an account of the user. The account data 112 includes, but is not limited to: an account number, a credit card number, and/or a user's name. The account data can be input into the controller 104 using an input device of the controller 104, such as a keypad, keyboard or touch screen. Alternatively, the controller 104 may be in communication with an external device from which it may receive the account data. For example, the external device maybe a cellphone, tablet computer or laptop computer.
3. A server 106 configured to receive the account data 112 and the transaction code from the controller 104. In an example embodiment, the server 106 may be configured to initiate authorization of the transaction once the transaction code is generated and the account data is received by the server 106. The server 106 may be at a remote location away from the controller 104 or may be at the same physical location. The controller 104 may be directly or indirectly connected to the server 106, e.g., connected via the Internet or a Local Area Network (LAN). The connection may be wired and/or wireless.
4. A database 108 in communication with the server 106 and having stored thereon the account data in association with a registered code. The database 108 may be at a remote location away from the server 106 or may be at the same physical location.
   The registered code is generated based on pre-obtained biometric information of the user. In an exemplary embodiment, during an enrollment phase, a user's biometric information is obtained at a location (e.g., a bank) where the identity of the user can be verified (e.g., by bank tellers who can inspect a passport or other identifying documentation). This is to ensure that the registered code corresponds to the correct user. During a verification phase, the registered code that has been generated based on the biometric information obtained beforehand during the enrollment phase (i.e., “pre-obtained”) is used as a reference with respect to the transaction code. As biometrics are generally unique to each individual, it is expected that the registered code that is based on pre-obtained biometric information is also generally unique to each user. Further details on the enrollment and verification phase will be provided below.

In an exemplary embodiment, the server 106 is operable to use the account data to identify the registered code in the database and to authorize the transaction based on a comparison of the registered code with the transaction code. In an example embodiment, the server 106 is operable to authorize the transaction if the transaction code corresponds with or matches the registered code. To allow for errors when obtaining the biometric data and/or generating the transaction code/registered code, an appropriate margin of error can be tolerated to authorize the transaction. For example, the errors may occur due to background noise or movement of the user whilst providing their biometric identifier. As such, it may not be necessary for the transaction code to exactly match the registered code. If there is an acceptable level of correspondence between the transaction code and the registered code, the transaction can be authorized. The level of correspondence can be determined by a system administrator. The server may also be operable to decline the transaction if the transaction code does not correspond with or match the registered code. For example, the system administrator can set an authorization threshold (for example “90%”) such that the server 106 is operable to authorize the transaction if the correspondence between the registered code and the transaction code is at or above the threshold. For example, the transaction code may have to be at least 90% the same as the registered code. In an embodiment, the server 106 is operable to decline the transaction if there is a less than 90% match between the transaction code and the registered code, i.e., the match is below the threshold. The matching (i.e., comparison) of the transaction code and the registered code can be performed by an appropriate matcher/comparator device or circuit as would be known to the person skilled in the art.

In an example embodiment, the system 100 may further comprise a first encryptor 114 in communication with the controller 104. The first encryptor 114 may be part of the controller 104 or may be separate to the controller 104. The first encryptor 114 is configured to encrypt the obtained biometric information such that the controller generates the transaction code based on the encrypted biometric information. The first encryptor 114 may encrypt the biometric information before it is delivered to the controller 104 such that the controller 104 never receives or stores the unencrypted biometric information. The obtained biometric information is preferably encoded so that unauthorized third parties cannot read it. For example, a malicious third party who gains unauthorized access to the controller 104 may be able to steal the encrypted biometric information, but will be unable to decrypt data to obtain the biometric information. The biometric information is encrypted using an encryption algorithm, using an encryption key, which specifies how the message is to be encoded. Authorized parties can decode the encrypted biometric information using a decryption algorithm.

In an example embodiment, the system 100 may further comprise a second encryptor 116 in communication with the controller 104. The second encryptor 116 may be part of the controller 104 or may be separate to the controller 104. The second encryptor 116 is configured to encrypt the generated transaction code such that the controller sends the encrypted transaction code to the server. That is, the encrypted transaction code is sent in place of the unencrypted transaction code. The second encryptor 116 may function in essentially the same way as the first encryptor 114. The generated transaction code is preferably encoded so that unauthorized third parties cannot read it. For example, a malicious third party who intercepts the encrypted transaction code in transit between the controller 104 and the server 106 will be unable to decrypt the data to obtain the biometric information. The generated transaction code is encrypted using an encryption algorithm, using an encryption key, which specifies how the message is to be encoded. Authorized parties can decode the encrypted biometric information using a decryption algorithm.

In another embodiment, a single encryptor may be used to encrypt both the obtained biometric information and the generated transaction code. That is, the functions of the first and second encryptors may be provided by a single encryptor.

In an example embodiment, the database 108 stores the account data (e.g., account number, a credit card number, a user's name) in association with user information (e.g., shipping address, billing address, user preferences, passwords, etc.) and the server 106 is further operable to provide the user information to the controller 104 if the transaction is authorized, for example, if the transaction code corresponds with or matches the registration code. In an exemplary embodiment, the user's information can be stored in an online payment wallet (a program or web service that allows users to store and control their online shopping information in one central place) and can be “unlocked” (i.e., the online shopping information can be accessed by the user and/or may be provided to the controller 104) if the transaction is authorized, for example, if the transaction code corresponds with or matches the registration code.

In an example embodiment, the server 106 is further operable to permit funds to be taken from the user's account if the transaction is authorized, for example, if the transaction code corresponds with or matches the registered code. For example, merchants can receive payment from the user for purchased goods and/or services. In an embodiment, the controller 104 may be permitted to take funds out of the account by the server 106. Additionally or alternatively, another entity may be permitted to take funds out of the account by the server 106. For example, the other entity may be an issuer (e.g., bank or financial institution) which administers an account of the merchant. Additionally or alternatively, the server 106 may transfer funds from the account to the controller 104 or the other entity.

In an example embodiment, the controller 104 is further configured to receive transaction data, and the server 106 is further configured to receive the transaction data from the controller 104. The server 106 can be operable to authorize the transaction based on the transaction data. In an embodiment, the transaction data comprises a transaction amount, for example, an amount of money to be exchanged for a good/service as part of the transaction. Also, the database 108 may store the account data in association with an amount of available funds in the account. For example, the account may be a credit card account and the amount of available funds may be the amount of available credit on the account. Alternatively, the account may be a checking account and the amount of available credit may be the amount of money held in the account. It is to be understood that the database will in this case store the account data in association with the amount of available funds in the account and with the above-described registered code. Further, the server 106 may be operable to use the account data to identify the amount of available funds in the account from the database and to authorize the transaction only if the amount of available funds in the account is equal to or greater than the transaction amount.

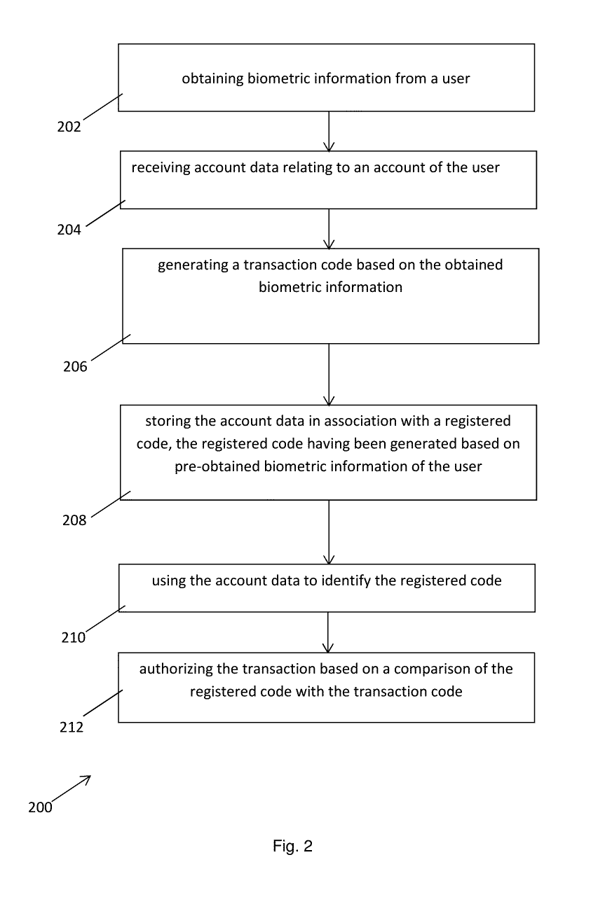

With reference to FIG. 2, according to another embodiment of the invention, there is provided a method of authorizing a transaction. The method (designated generally as reference numeral 200) comprises the following:
Block 202: Obtaining biometric information from a user. The biometric information can be obtained using a biometric scanner and sent to a controller.
Block 204: Receiving account data relating to an account of the user. The controller can be configured to receive the account data.
Block 206: Generating a transaction code based on the obtained biometric information. The controller can be configured to generate the transaction code.
Block 208: Storing the account data in association with a registered code, the registered code having been generated based on pre-obtained biometric information of the user. The account data in association with the registered code can be stored in a database.
Block 210: Using the account data to identify the registered code. For example, every account is associated with a unique registration code. Every account may also be associated with one or more types of account data, e.g. an account number, a credit card number, a user's name. Therefore, account data that is received can be used to identify, from a list of accounts, the account that matches the received account data. The unique registration code that is associated with the matched account can thus be identified.
Block 212: Authorizing the transaction based on a comparison of the registered code with the transaction code. For example, the transaction can be authorized if the transaction code corresponds with or matches the registered code. Also, the transaction can be declined if the transaction code does not correspond with or match the registered code.

The block 206 may further comprise:
(i) encrypting the obtained biometric information; and
(ii) generating the transaction code based on the encrypted biometric information, rather than the unencrypted biometric information.

In an embodiment, the obtained biometric information is encoded so that unauthorized third parties cannot read it. The biometric information is encrypted using an encryption algorithm, using an encryption key, which specifies how the message is to be encoded. Authorized parties can decode the encrypted biometric information using a decryption algorithm.

The method 200 may further include encrypting the generated transaction code. In an embodiment, the generated transaction code is encoded so that unauthorized third parties cannot read it. The generated transaction code is encrypted using an encryption algorithm, using an encryption key, which specifies how the message is to be encoded. Authorized parties can decode the encrypted biometric information using a decryption algorithm.

The method 200 may further comprise the step of permitting funds to be taken from the account if the transaction is authorized, for example, if the transaction code corresponds with or matches the registered code.

The method 200 may further comprise:
(i) receiving transaction data (e.g., a transaction amount); and
(ii) authorizing the transaction based on the transaction data.

If the transaction data comprises a transaction amount, the block 208 may further include storing the account data in association with an amount of available funds in the account. Also, block 210 may further include using the account data to identify the amount of available funds in the account. Additionally, block 212 may include authorizing the transaction only if the amount of available funds in the account is equal to or greater than the transaction amount.

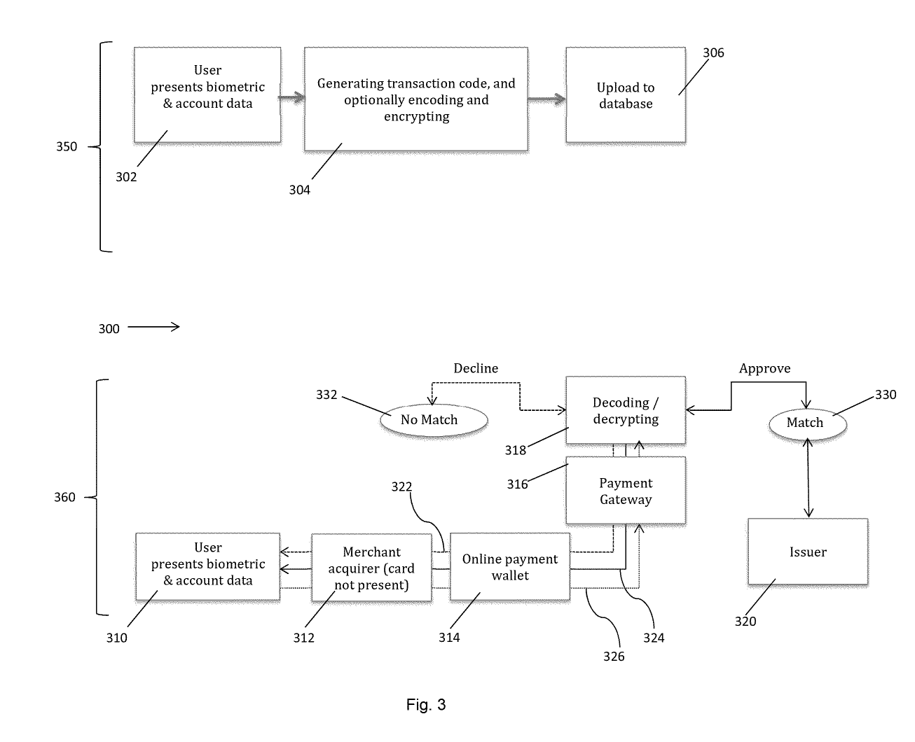

FIG. 3 is a sequence diagram, designated generally as reference numeral 300, of a method of authorizing a transaction, according to an embodiment of the invention. The method comprises two separate phases: an enrollment (e.g., registration) phase 350 and a verification (e.g., authorization) phase 360.

The enrollment phase 350 includes three initialization blocks (302, 304, and 306) which are performed prior to the verification phase 360. These three initialization blocks may only be performed once. After these three initialization blocks are completed, a user may only need to perform the blocks in the verification phase 360 to repeat or authorize the transaction.

The three initialization blocks of the enrollment phase 350 are: presentation block 302, generation block 304, and uploading block 306. At presentation block 302, a user presents his biometric identifier (e.g., fingerprint, DNA, face, iris, retina, etc.) and one or more types of account data associated with his account (e.g., an account number, a credit card number, a user's name). An appropriate biometric scanner is used to generate a digital representation based on a biometric identifier of the user. In this way, the user's unique biometric information (comprising the digital representation) may be obtained. This block is advantageously performed at a location (e.g., a bank) where the identity of the user can be verified (e.g., by bank tellers). In an embodiment, the biometric information may be encoded and/or encrypted so that if a malicious third party gains unauthorized access to the digital representation, the third party will not be able to identify the biometric information.

At generation block 304, a unique registered code is generated based on the user's unique biometric information which contains the digital representation obtained from the biometric scanner. For example, the registered code is generated by converting the biometric information of the user into an alphanumeric, numeric or binary code. As mentioned above, this biometric information may be encoded and/or encrypted. Additionally, the registered code may itself be encoded and/or encrypted to avoid malicious usage by third parties. As biometric identifiers are generally unique to each individual, it is expected that the registered code that is based on the biometric information is also generally unique to each user.

At uploading block 306, the user's account data and associated registered code are uploaded and stored on a database.

Once the three initialization blocks (302, 304, and 306) are performed, the enrollment phase 350 is complete. The verification phase 360 can commence and is performed whenever a user wishes to authorize a transaction.

The blocks in the verification phase 360 will be elaborated using the following example. In FIG. 3, the dotted arrows 326 designate an “authorization request”, the dashed arrows 322 designate a “decline flow”, and the solid arrows 324 designate an “approval flow”. Suppose a consumer uses an application that is installed on his mobile phone to shop for goods and/or services that are offered by a merchant, and wishes to pay for goods and/or services that he wishes to purchase. At block 310, the user presents his biometric identifier (e.g., fingerprint) for authorization. For example, the user can use a fingerprint scanner built into his mobile phone to present his biometric identifier. The fingerprint scanner is configured to generate a digital representation based on his fingerprint. In this way, biometric information is obtained, which comprises the digital representation of the fingerprint. The user also presents his account data (e.g., account number). The application that is installed on his mobile phone may prompt the user to input his account data (e.g., account number) using the mobile phone's keypad or touch screen.

At block 312, the merchant or acquirer (e.g., bank or financial institution that processes credit and/or debit card payments for products or services for a merchant) requests verification of the consumer in order to authorize the transaction (i.e., “authorization request 326”). Embodiments of the present invention are especially suited for “card not present” transactions (i.e., payment card transactions where the cardholder is not physically present with the card at the merchant or acquirer at the time the payment is effected). Such transactions are common in internet or online shopping scenarios. Thus, the authorization request 326 may request authorization to make a payment.

Optionally, at block 314, the authorization request 326 may request that an online payment wallet (e.g., a program or web service that allows users to store and control their online shopping information in one central place) is unlocked so that the online shopping information can be accessed. Thus, the authorization request 326 may request authorization to access an online payment wallet.

Although not shown in FIG. 3, the verification phase 360 involves generating a transaction code based on the obtained biometric information (from block 310). For example, the transaction code is generated by converting the biometric information of the user into an alphanumeric, numeric or binary code. The transaction code is preferably encoded and/or encrypted to avoid malicious use of the biometric information corresponding to the transaction code. This block is similar to block 304 of the enrollment phase 350.

At block 316, a payment gateway 316 receives the authorization request 326. The payment gateway 316 may be implemented on a server device or system. The payment gateway 316 can be configured to process and authorize payment transactions. For example, the payment gateway 316 can be configured to obtain the account data (e.g., account number) and transaction code for authorization of the transaction.

At block 318, the encrypted transaction code is decrypted and/or decoded. The transaction code is compared with the registered code that is stored at the database (see block 306). If the transaction code corresponds with or matches the registered code, as indicated by block 330, the transaction is authorized and the issuer is notified accordingly (block 320). In this instance, the approval flow 324 is initiated and the online payment wallet may be unlocked and the merchant/acquirer notified accordingly. Additionally or alternatively, a requested payment may be made when the approval flow 324 is complete.

If the transaction code does not correspond with or match the registered code, as indicated by block 332, the transaction is declined, i.e., not authorized. In this instance, the decline flow 322 is initiated and the online payment wallet may remain locked and the merchant/acquirer notified accordingly. Additionally or alternatively, a requested payment may not be made when the decline flow 322 is complete.

There may be one or more additional conditions for authorization, including sufficient funds in a debit/pre-paid account, or a credit limit of a credit account has been not been exceeded. For example, if the additional condition for authorization is the requirement for sufficient funds in a debit/pre-paid account, account data (comprising the account number) is obtained (e.g., at block 310). The payment gateway 316 checks with an issuer (e.g., a bank) 320 or financial services corporation if there are sufficient funds in the debit/pre-paid account identified by the account number. If there are sufficient funds, as indicated by 330, an approval flow 324 is initiated. On the other hand, if there are insufficient funds as indicated by 332, the decline flow 322 is initiated and the transaction is not completed.

Some embodiments of the present invention are suited for “card not present” transactions and advantageously do not require consumers to have their credit card with them at all times, nor remember both their credit card numbers and card security codes (i.e., card verification data (CVD), card verification number (CVN), card verification value (CVV or CVV2), card verification value code (CVVC), card verification code (CVC or CVC2), verification code (V-code or V code), card code verification (CCV), or signature panel code (SPC)) in order to complete transactions.

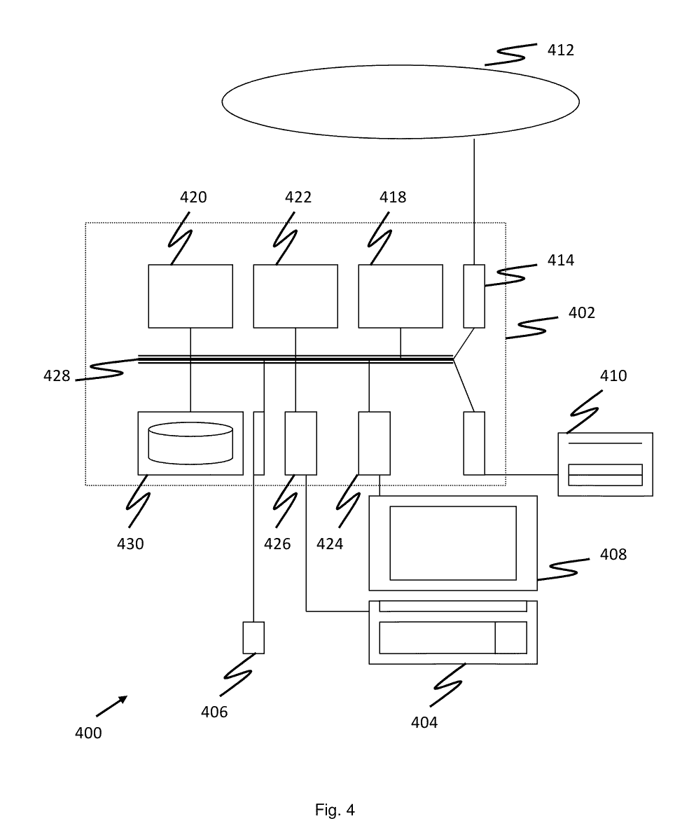

The method(s) and/or system(s) of the example embodiments can be at least partly implemented on a computer system 400, schematically shown in FIG. 4. Some embodiments can be implemented on a computer network comprising a plurality of interconnected computer systems 400. It may be implemented as software, such as a computer program being executed within the computer system(s) 400, and instructing the computer system(s) 400 to conduct the method of the example embodiment. For example, the server 106 and the database 108 can be implemented using the computer system 400. Also, the controller 104 can be implemented using a separate but similar computer system 400.

The computer system 400 comprises a computer module 402, input modules such as a keyboard 404 and mouse 406 and a plurality of output devices such as a display 408, and printer 410.

The computer module 402 is connected to a computer network 412 via a suitable transceiver device 414, to enable access to e.g., the Internet or other computer networks and/or systems such as Local Area Network (LAN) or Wide Area Network (WAN).

The computer module 402 in the example includes a processor 418, a Random Access Memory (RAM) 420 and a Read Only Memory (ROM) 422. The computer module 402 also includes a number of Input/Output (I/O) interfaces, for example I/O interface 424 to the display 408, and I/O interface 426 to the keyboard 404.

The components of the computer module 402 typically communicate via an interconnected bus 428 and in a manner known to the person skilled in the relevant art.

The application program is typically supplied to the user of the computer system 400 encoded on a data storage medium such as a CD-ROM or flash memory carrier and read utilizing a corresponding data storage medium drive of a data storage device 430. The application program is read and controlled in its execution by the processor 418. Intermediate storage of program data may be accomplished using RAM 420.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

What is claimed is:

1. A system for authorizing a transaction, comprising:
a biometric scanner configured to obtain biometric information from a user;
a controller configured to receive the obtained biometric information from the biometric scanner and to generate a transaction code based on the obtained biometric information, the controller being further configured to receive account data relating to an account of the user;
a server configured to receive the account data and the transaction code from the controller;
a database in communication with the server and having stored thereon the account data in association with a registered code, the registered code having been generated based on pre-obtained biometric information of the user; and
wherein the server is operable to use the account data to identify the registered code and to authorize the transaction based on a comparison of the registered code with the transaction code.

2. The system of claim 1, wherein the server is operable to authorize the transaction if the transaction code corresponds with or matches the registered code.

3. The system of claim 1, wherein the server is operable to decline the transaction if the transaction code does not correspond with or match the registered code.

4. The system of claim 1, further comprising a first encryptor in communication with the controller, the first encryptor configured to encrypt the obtained biometric information such that the controller generates the transaction code based on the encrypted biometric information.

5. The system of claim 1, further comprising a second encryptor in communication with the controller, the second encryptor configured to encrypt the generated transaction code such that the controller sends the encrypted transaction code to the server.

6. The system of claim 1, wherein the biometric scanner comprises a fingerprint scanner configured to generate a digital representation based on a fingerprint of the user, and the biometric information comprises the digital representation.

7. The system of claim 1, wherein the biometric scanner comprises an image capturing device configured to generate a digital representation based on an iris or retina of the user, and the biometric information comprises the digital representation.

8. The system of claim 1, wherein the account data comprises one or more of: an account number, a credit card number, a user's name.

9. The system of claim 1, wherein the database stores the account data in association with user information and the server is further operable to provide the user information to the controller if the transaction is authorized.

10. The system of claim 1, wherein the server is further operable to permit funds to be taken from the account if the transaction is authorized.

11. The system of claim 1, wherein the controller is further configured to receive transaction data; and the server is further configured to receive the transaction data from the controller; and
wherein the server is operable to authorize the transaction based on the transaction data.

12. The system of claim 11, wherein the transaction data comprises a transaction amount and the database stores the account data in association with an amount of available funds in the account, wherein the server is operable to use the account data to identify the amount of available funds in the account and to authorize the transaction only if the amount of available funds in the account is equal to or greater than the transaction amount.

13. The system of claim 1, wherein the controller is configured to generate the transaction code and registered code by converting the biometric information of the user into alphanumeric, numeric or binary codes.

14. A method of authorizing a transaction, the method comprising:
obtaining biometric information from a user;
receiving account data relating to an account of the user;
generating a transaction code based on the obtained biometric information;
storing the account data in association with a registered code, the registered code having been generated based on pre-obtained biometric information of the user;
using the account data to identify the registered code; and
authorizing the transaction based on a comparison of the registered code with the transaction code.

15. The method of claim 14, wherein authorizing comprises authorizing the transaction if the transaction code corresponds with or matches the registered code.

16. The method of claim 14, wherein authorizing comprises declining the transaction if the transaction code does not correspond with or match the registered code.

17. The method of claim 14, wherein generating comprises: encrypting the obtained biometric information; and
generating the transaction code based on the encrypted biometric information.

18. The method of claim 14, further comprising encrypting the generated transaction code.

19. The method of claim 14, further comprising the step of permitting funds to be taken from the account if the transaction is authorized.

20. The method of claim 14, further comprising: receiving transaction data; and
wherein authorizing the transaction is based on the transaction data.

21. The method of claim 20, wherein storing comprises storing the account data in association with an amount of available funds in the account,
wherein using comprises using the account data to identify the amount of available funds in the account,
wherein the transaction data comprises a transaction amount, and
wherein authorizing comprises authorizing the transaction only if the amount of available funds in the account is equal to or greater than the transaction amount.

22. The method of claim 14, further comprising the step of generating the transaction code and registered code by converting the biometric information of the user into alphanumeric, numeric or binary codes.
